(19) United States
(12) Patent Application Publication
(10) Pub. No.: US 2018/0369640 A1
(43) Pub. Date: Dec. 27, 2018

(54) FORCE INDICATING SYSTEM FOR GROUND AND WALL EXERCISES WITH A WEIGHTED BALL OR SIMILAR EXERCISE EQUIPMENT DESIGNED FOR STRIKING

(71) Applicant: ANTHONY SEAY HURST, Georgetown, KY (US)

(72) Inventor: ANTHONY SEAY HURST, Georgetown, KY (US)

(21) Appl. No.: 15/629,835

(22) Filed: Jun. 22, 2017

(51) Int. Cl. A63B 24/00; G01L 5/00

(52) U.S. Cl. CPC A63B 24/0062; A63B 69/00; G01L 5/0052

(57) ABSTRACT

An exercise device design for capturing the force dispersed by slamming a weighted exercise ball or similar heavy exercise equipment designed to strike, hit, or throw. The device is design to lay flat on the floor or be mounted by fasteners to a solid surface such as a wall. An example of use would be when a user turns the device on by pressing the device buttons and takes a weighted medicine ball and slams the ball into the device's target and sensor. After the device's sensor is struck by the ball the device's display would inform the user how much force was exert by the ball slamming into the sensor. This exercise of slamming the weighted ball can be repeated until the user is satisfied.

### CROSS-REFERENCE TO RELATED APPLICATIONS

This application claims the benefit of provisional patent application No. 62/361,418, filed 2016 Jul. 12 by the present inventor.

### SEQUENCE LISTING

Non-applicable.

### BACKGROUND

The following is a tabulation of some prior art that presently appears relevant:

| U.S. Patent or | | | |
|---|---|---|---|
| Publication Number | Kind Code | Issue Date | Patentee |
| 20160045757 | A1 | 2016 Feb. 18 | JAMES |
| 009,272,184 | B1 | 2016 Mar. 1 | JAMES |
| 008,333,104 | B1 | 2012 Dec. 18 | OBERLEITNER |
| 007,308,818 | B2 | 2007 Dec. 18 | CONSIDINE et al. |
| 20150094191 | A1 | 2015 Apr. 2 | FRADIN |

This invention relates to exercise equipment used for capturing the numerical values of force in physical exercise movements. The treadmill gives a time, distance, and speed for the runner to see and improve on. The row machine gives similar numerical data such as the distance, time, and calories burned. Unlike these exercise machines many exercises still do not have quantifiable data to benefit the exerciser. One exercise with no feedback or force measurement is slamming a weighted ball with full force against the ground or wall. Another similar exercise that does not have any device to provide feedback or display a specific force measurement is striking an exercise sledgehammer at full force. These type of movements and many exercises do not currently have a means to technologically capture the force in striking and record the amount of strikes. Therefore these forces that correlate to the exercise movement are unknown to the individuals performing the exercise. These unknowns are a hindrance to improving physical fitness and strength levels. Being aware of the amount of force exerted by the exercise is beneficial for improvement in strength and fitness. The fitness industry is continually seeking to improve by implementing technology to exercise. Implementing technology in exercises and equipment can give the individual exercising more performance data information that they can use to improve.

One method for tracking exercise activities and giving the exerciser beneficial information is U.S. Pub. No. 2016/0045787 for “Exercise Contact Counter Display Tracking Repetitive Hits” by James et al., published on Feb. 18, 2016. Unlike the proposed invention, James et al.'s device does not capture the impact or force of the exercise the user performs. Similar to the proposed invention, James et al.'s device captures the amount of hits or repetitive contacts to inform the user how many times they perform an exercise.

U.S. Pat. No. 8,333,104 for “Measuring Instrument for the Detection and Evaluation of an Impact” by Oberleitner, issued on Dec. 18, 2012, consists of an impact sensing pad with emphasis on handheld devices to capture impact forces from striking. As shown in Oberleitner's drawings, implementation forms for the measurement instrument are via a Coaching Mitt or a Hand Mitt. Unlike the proposed invention the purpose of Oberleitner's device is not intended to be fastened to rigid constructions such as the wall or lay flat on the floor. Similar to the present invention, Oberleitner's invention provides feedback data, consisting of the average force and number of impacts.

Another method used to capture impact data produced through striking is shown in U.S. Pat. No. 7,308,818 for “Impact-Sensing and Measurement Systems, Methods for Using Same, and Related Business Methods” by Considine et al., issued on Dec. 18, 2007. Unlike the proposed invention Considine et al. utilize accelerometers or other impact sensors configured to sense accelerations in three spatial axes. Unlike the present invention Consdine et al. uses impact sensors that sense accelerations in multiple directions that are beneficial for capturing forces exerted on equipment which moves when struck, such as a punching bag, dummy, etc. Similar to the present invention, Considine et al.'s invention provides feedback data, consisting of the average force and number of impacts.

U.S. Pub. No. 2015/0094191 for “Punching Bag Force Measurement System” published on Apr. 2, 2015 by Fradin shows a force measurement system device for punching bags. Unlike the proposed invention this force measurement system has multiple sensors, wraps and tightens around a punching bag, and is for measuring a force from a first or foot. This punching bag force measurement system is not configured to lay on a floor or mount to a wall. Unlike the present invention Fradin's invention is not configured to receive strikes on the floor or wall from weighted exercise balls or heavy exercise equipment intended for striking. Unlike the present invention the sensors used are accelerometers to measure impact. Similar to the proposed invention the punching bag force measurement system keeps track of the total number of hits, and average force of the hits.

In conclusion, as to my awareness, no impact capturing and impact counting exercise device is developed to be flat on the floor or other solid surface, and struck with a weighted ball or similar heavy exercise equipment designed for throwing, striking, or slamming.

### SUMMARY OF THE PRESENT INVENTION

The invention is a force sensing device used on the floor or fastened to the wall to indicate the force generated from an individual throwing a weighted ball, swinging a sledge hammer, or similar equipment and striking the device's force sensor. When the force sensing device is hit or struck a numerical value of the impacts force and other important exercise information will display. The main componentry shall consist of a durable pad with a force sensor, a circuit board to capture and store the exercise information, and a display to show the user important exercise data. Data captured and displayed to the user includes, but is not limited to, the most recent hit force, the amount of hits, the average force of the hits, the total cumulative force from all hits, and a timer.

The invention provides several advantages to the exercises involving slamming a weighted ball, striking with a sledgehammer, or equivalent heavy striking exercise equipment. The device will provide the exerciser important feedback on the amount of force exerted during the exercise. This force is an important value to know enabling the user and competitors in the exercise to exert more energy to have the higher force. The device will take the force from each hit and provide the user with expounded data based on the forces involved in the user hits. Other important feature is the hit counter, and timer which will allow the user to keep track of how much time and how many times the exercise is performed. Further objects and advantages will be revealed from the following description and drawings.

### DRAWINGS—FIGURES

FIG. 1 is a top view of the device and also a view from the user's perspective when exercising with the device.

FIG. 2 is a cross sectional view of the device showing the componentry used to create its functionality.

FIG. 3 shows an exploded view of the device and highlights the individual components. The exploded view also shows how the components are layered for proper construction of the device.

FIG. 4 is an isometric view of the device indicating the external construction items that will be visible to the user.

### REFERENCE NUMERALS

| | |
|---|---|
| 10 | Digital display |
| 20 | Housing for display, battery, and processor |
| 30 | Durable mat for absorbing impact force |
| 40 | Durable target adhered to durable mat |
| 50 | Processor for device |
| 60 | Wiring from processor to resistor |
| 70 | Force sensitive resistor sensor |
| 80 | Durable mat adhered to underside of unit |
| 90 | Clear window for digital display |
| 100 | Battery of device |
| 110 | Permanent adhesion material |

### DETAILED DESCRIPTION AND OPERATION

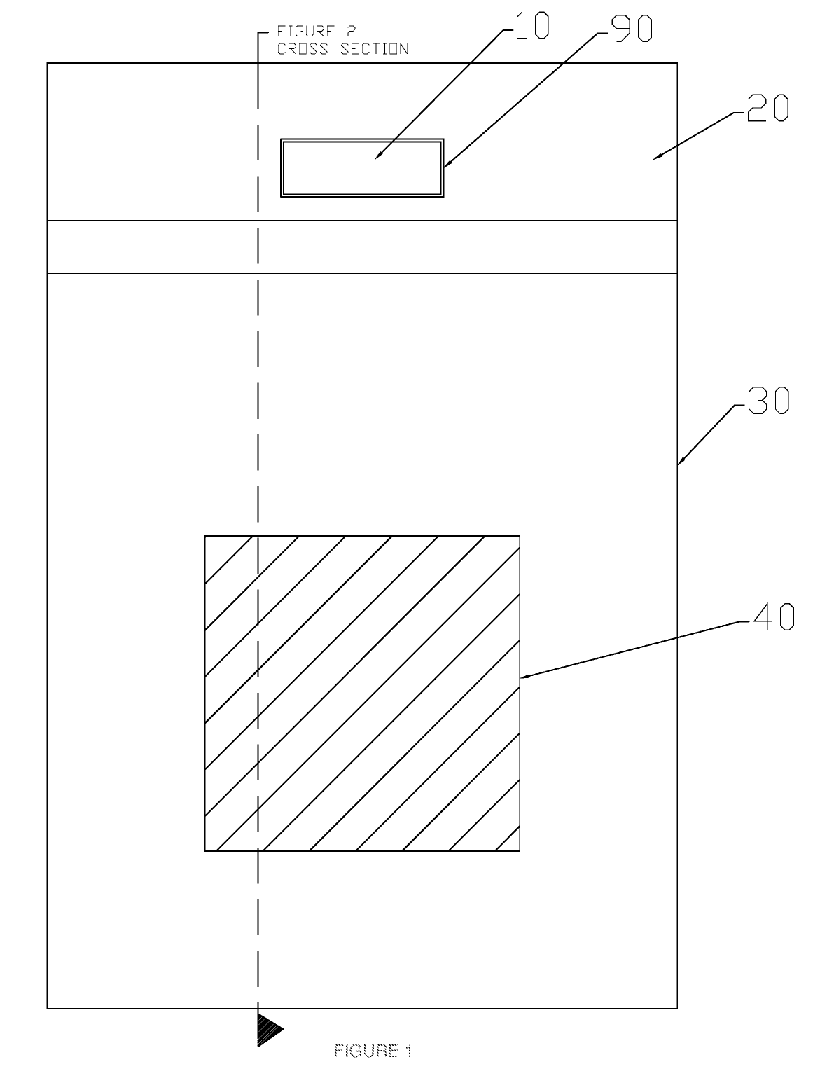

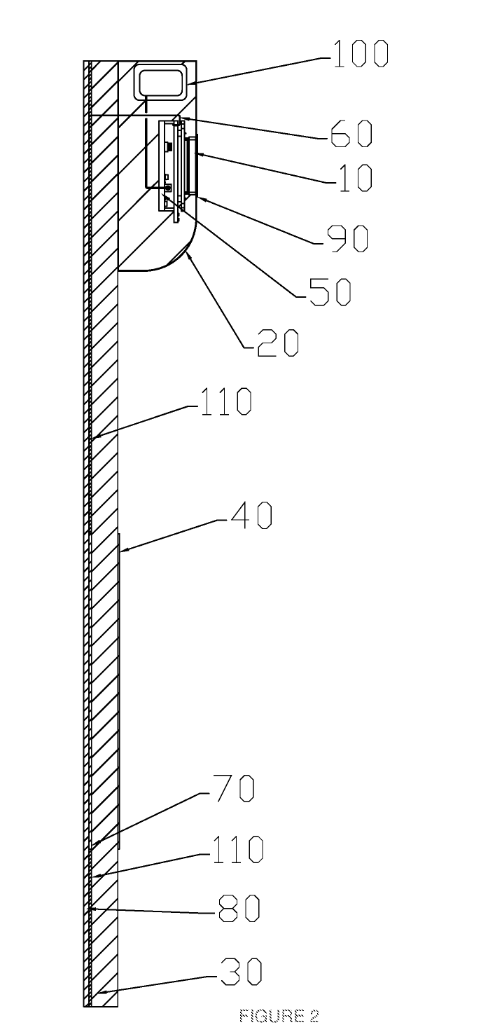

FIG. 1 is a view from the user's perspective when exercising with the device. The durable target 40 is adhered to, and located toward the lower center of the durable mat for absorbing impact force 30. The durable target 40 is to be located directly above device's force sensitive resistor sensor 70 as shown in FIG. 2. FIG. 1 also shows the housing 20 for the device's display, battery, and processor. The housing 20 for display, battery, and processor is to have a clear window 90 to provide vision of the digital display. FIG. 1 provides a cross sectional reference to FIG. 2 which shows further detail of the reference numerals.

FIG. 2 provides a cross sectional view of the device's components and details on how they are arranged. The bottom of the device will be a durable mat 80 adhered to the underside of the unit by a permanent adhesive material 110. Between the bottom durable mat 80 and top durable mat 30 shall be the devices wiring 60 and force sensitive resistor sensor 70. The permanent adhesion material 110 will not be used in the area occupied by the force sensitive resistor sensor 70. A durable mat for absorbing impact force 30 will be located above the force sensitive resistor 70. On the durable mat 30 there will be a target 40 adhered to its surface indicating where to strike the mat to register an impact force on the force sensitive resistor sensor 70. The housing 20 for the display, battery, and processor shall be fastened to the durable mat 30, and wiring shall penetrate through the durable mat 30 and be routed to the force sensitive resistor sensor 70. In the housing 20 will be located the digital display 10, processor for the device 50, and battery with associated wiring. The internal components are mounted to the housing 20. A clear window 90 in the housing 20 will enable the device user to see the digital display 10 during operation. On the housing 20 is located a control panel to power on/off the device, and reset the display.

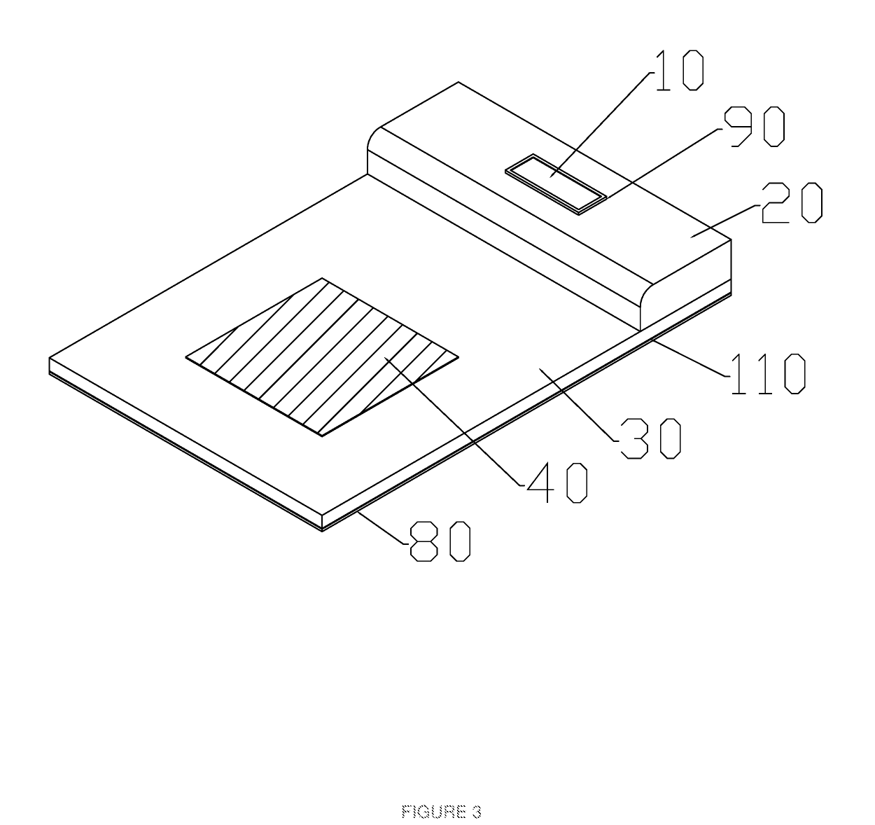

The isometric FIG. 3 is presented to provide a perspective view of the device when it is located in a place for operation. The device is intended to be located on the floor or wall. In FIG. 3 the main items visible during operation will be the thicker durable mat 30 for impact force, the target 40 adhered to the durable mat 30, the housing 20 with a clear window 90, the digital display 10, the permanently adhered material 110, and the bottom side durable mat 80. All the exterior materials are of durable nature and able to withstand impact from a weighted ball or similar striking device. When a sledgehammer or equivalent striking equipment is used the durable mat is capable of strikes from such equipment, but the housing 20 in the instance of a sledgehammer will only be resistant to major damage. The base consists of rubber or a material of equivalent durability and labeled in figures as the durable mats 30 and 80, and the adhered target 40. The thickness for these drawing numerals will be different thicknesses as shown in FIG. 2.

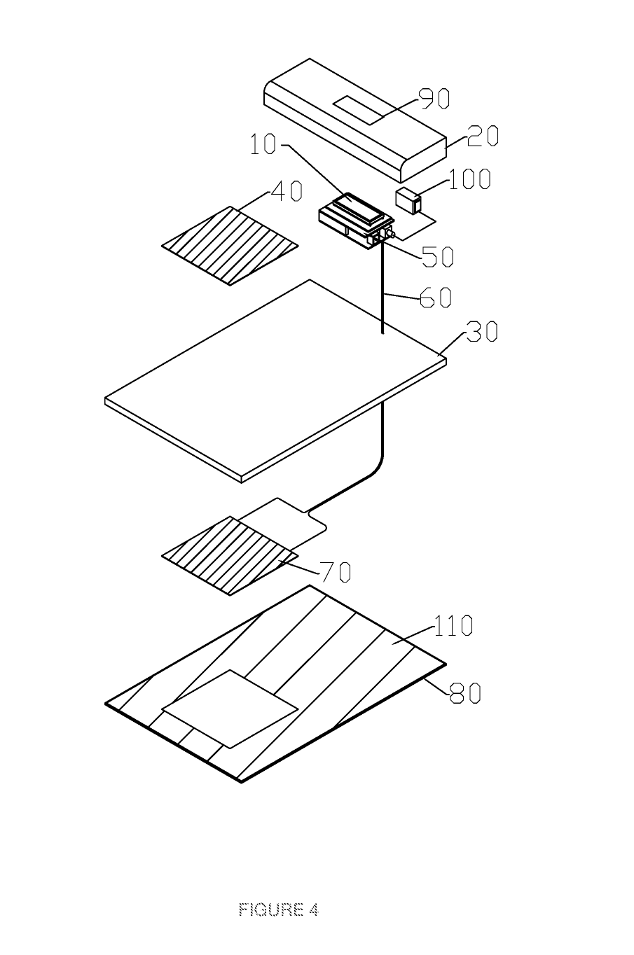

A final understanding of the device's components and how they are arranged is shown in FIG. 4. All of the items are layered as shown in the exploded isometric view. The housing 20 with its clear window 90 contain the digital display 10, battery with associated wiring 100, and the processor 50. Wiring 60 from the processor 50 will be routed through the thick durable mat 30 to the force sensitive resistor sensor 70. A durable target is adhered to the top of the durable mat 30. The bottom durable mat 80 of the device will be permanently adhered 110 to the top durable mat 30. The permanent adhesive material will not be applied where the force sensitive resistor sensor 70 is located.

Operation of the device consists of the digital display 10 that has controls that are located on the housing 20 and used to power on/off the device, and reset the display. Once the user has powered on the device and allowed the display 10 to set, they can proceed to exercising by slamming a weighted ball into the sensor 70 and target 40. Other heavy striking exercise devices such as a sledgehammer used for exercise shall also be capable of being used with the invention for exercise. When the device is still on and the user desires to reset the display 10 a reset button is provided on the housing 20.

I claim:

1. A force indicating system used for ground and wall exercises with a weighted ball or similar heavy exercise equipment designed for striking.

2. The force indicating system of claim 1 wherein said body utilizes a controller or processor capable of capturing the device hit forces and displaying them on a digital display. The display values during use of the force indicating system of claim 1 wherein include but are not limited to the most recent hit force, the average hit force, the cumulative force from all counted hits, and time.

3. The force indicating system of claim 1 wherein said body has a durable housing for the controller or processor in claim 2, digital display in claim 2, and battery. The durable housing is capable of protecting the device components during an exercise and use.

4. The force indicating system of claim 1 wherein said body utilizes a durable material base that is fastened to the housing enclosure of claim 3 for the device electronics of claim 2 and claim 3.

5. The force indicating system of claim 1 wherein said body has a force sensitive resistor sensor designed for high impact and capable of capture high forces from a weighted ball or similar. The force sensor is located between an upper durable material of claim 4 and a lower durable material similar to that of claim 4. The durable materials wherein said body are permanently adhered together. The permanent adhesion of the durable materials is not applied where the force sensitive resistor of this claim is located.
